(19) United States
(12) Patent Application Publication
(10) Pub. No.: US 2010/0306123 A1
(43) Pub. Date: Dec. 2, 2010

(54) INFORMATION RETRIEVAL METHOD, USER COMMENT PROCESSING METHOD, AND SYSTEMS THEREOF

(75) Inventors: Keke Cai, Beijing (CN); Rui Ma, Beijing (CN); Zhong Su, Beijing (CN); Xiao Xun Zhang, Beijing (CN); Hui Jia Zhu, Beijing (CN)

Correspondence Address: IBM CORPORATION, T.J. WATSON RESEARCH CENTER, P.O. BOX 218, YORKTOWN HEIGHTS, NY, 10598, US

(73) Assignee: INTERNATIONAL BUSINESS MACHINES CORPORATION, Armonk, NY (US)

(21) Appl. No.: 12/787,870

(22) Filed: May 26, 2010

(30) Foreign Application Priority Data
May 31, 2009 (CN) 200910141899.8

(51) Int. Cl. G06Q 99/00

(52) U.S. Cl. 705/347

(57) ABSTRACT

A user comment processing method and system and an information retrieval method and system. The user comment processing method includes the steps of: receiving objective data of a feature of a product or service and user comments on the product or service; identifying user comments associated with the feature of the product or service from the user comments on the product or service; identifying the opinion facet in the user comments associated with the feature of the product or service; establishing association-relationship between the opinion facet and the objective data of the corresponding feature of the product or service, and calculating an occurrence frequency of the opinion facet associated with the objective data; and creating an association rule of the opinion facet and the objective data according to the association-relationship and the occurrence frequency of the opinion facet associated with the objective data.

### CROSS REFERENCE TO RELATED APPLICATION

This application claims priority under 35 U.S.C. 119 from Chinese Patent Application 200910141899.8, filed May 31, 2009, the entire contents of which are incorporated herein by reference.

### BACKGROUND OF THE INVENTION

1. Field of the Invention

The present invention generally relates to an information retrieval method, a user comment processing method and systems thereof, and particularly relates to a method and system for processing user comments on related products or services, and a method for retrieving products or services based on knowledge obtained by the processing of the user comments on related products or services.

2. Description of Related Art

Currently, many users want to find information about products or services they want to purchase through the internet. One typical approach is a manner of retrieval provided by related vendors or network service provider (such as a web site of digital products, a web site for hotel booking, a web site for consultancy services, and the like) for users as shown in FIG. 1, wherein features of a product or service in which users might be interested and their corresponding data are listed by related vendors or network service providers, and related options are set by a purchaser, so related products are recommended for the user specifically. But the descriptions for a product tend to be specialized terminologies, and it is difficult for an ordinary people to relate specialized terminologies with real usage. Further, the merchants may exaggerate qualities of their products.

Such subjective expressions are insufficient to determine the real product performance and service level. Users, especially some primary users, only have some sentiment concepts for their interested product or services. For example, a mobile user often thinks of “I need a mobile which is light, fashion, cost appropriate, of woman-style, . . . ”. But sentiment concepts vary with time, area etc. With general objective data, it is difficult to recommend appropriate products for individual users. Another typical way is by means of search as shown in FIG. 2 by inputting keywords “big screen cell phone” in a search engine. Existing search engines often simply present products or services containing related keywords. Such searching results are often one-sided and inaccurate, and the number of products and services obtained are too many to be examined by users what product or service should be selected for their need.

Further, with respect to existing products and services, there are a large number of user comments as shown in FIG. 3. Techniques have been proposed to analyze user comments to provide a polarity judgment for a feature of a product or service. The general processing procedure is as follows:

Step 1. identify a feature of a particular product in user comments (such as “screen”);

Step 2. identify the user comments associated with the feature of the product from user comments (big/good/poor);

Step 3. make a polarity judgment on the identified user comments (positive comment (big/good))/negative comment (poor));

Step 4. generate a polarity judgment for a particular feature of the particular product.

Such analysis manner provides users with an overall impression of a particular product on feature level, and has somewhat advantage. However, considering difference among user individuals, even all users give positive comments on a feature of a particular product, reasons behind might be very different. For example, for positive comments on a screen, user A gives such comments for its big size, users B for its vivid color, but user C for pixels of the screen. Existing techniques ignore these differences totally, and so can not provide more useful information for users.

### SUMMARY OF THE INVENTION

The present invention provides a user comment processing method and system related program products.

In accordance with an aspect of the present invention, a computer-implemented method for processing user comments, includes the steps of: receiving objective data of a feature of a product or service and user comments on the product or service, the user comments including comments associated with the feature; identifying user comments associated with the feature of the product or service from the other user comments on the product or service; identifying an opinion facet in the user comments associated with the feature of the product or service; establishing association-relationship between the opinion facet and the objective data of the corresponding feature of the product or service, and calculating an occurrence frequency of the opinion facet associated with the objective data; and creating an association rule between the opinion facet and the objective data according to the association-relationship and the occurrence frequency of the opinion facet associated with the objective data. Each of the steps is performed by a data processing machine.

In accordance with another aspect of the present invention, a system for processing user comments includes: receiving means for receiving objective data of a feature of a product or service and user comments on the product or service; feature identifying means, for identifying user comments associated with the feature of the product or service from the user comments on the product or service; sentiment identifying means for identifying an opinion facet in the user comments associated with the feature of the product or service; association and frequency computing means for establishing association-relationship between the opinion facet and the objective data of the corresponding feature of the product or service, and calculating an occurrence frequency of the opinion facet associated with the objective data; and association rule generation means for creating an association rule of the opinion facet and the objective data according to the association-relationship and the occurrence frequency of the opinion facet associated with the objective data.

In accordance with a further aspect of the present invention, computer programs, when executed by a computer, cause the computer to perform the above method and/or to function as the above system.

With the method and system of the present invention, an association-relationship and association rule between user sentiment and objective data of a product or service can be setup accurately and deeply. On the other hand, with such association-relationship and association rule, information on products or services that a user desires to know can be located more accurately for the user, and excellent reference information can be provided for exploitation and development of a new product and service.

### BRIEF DESCRIPTION OF THE DRAWINGS

Detailed description of features and advantages of embodiments of the present invention are given by referring to the following Figures. Same or similar components in different figures and the descriptions are denoted with same or similar reference number, if possible. In the drawings:

FIG. 1 is a schematic diagram of a method for making a search given data of features of a product or service;

FIG. 2 shows retrieval result by searching products or services using a search engine;

FIG. 3 shows related comments from users on a product or service;

FIG. 4 shows objective data of related product or services provided by a manufacture or service provider;

FIG. 5 is a schematic flowchart of a user comment processing method according to an embodiment of the present invention;

FIG. 6 is a schematic flowchart for identifying a feature of a product or service;

FIG. 7 is a schematic flowchart for identifying an opinion facet and its sentiment polarity according to an embodiment of the present invention;

FIG. 8 is a schematic diagram for summarizing a polarity of an opinion facet according to an embodiment of the present invention;

FIG. 9 is a schematic flowchart for estimating a probability function according to an embodiment of the present invention;

FIG. 10 is a schematic diagram of a probability function as an association rule according to an embodiment of the present invention;

FIG. 11 is a schematic flowchart of an information retrieval method according to an embodiment of the present invention;

FIG. 12 is a schematic diagram of configurations of a user comment processing system according to an embodiment of the present invention; and

FIG. 13 is a schematic diagram of configuration of an information retrieval system according to an embodiment of the present invention.

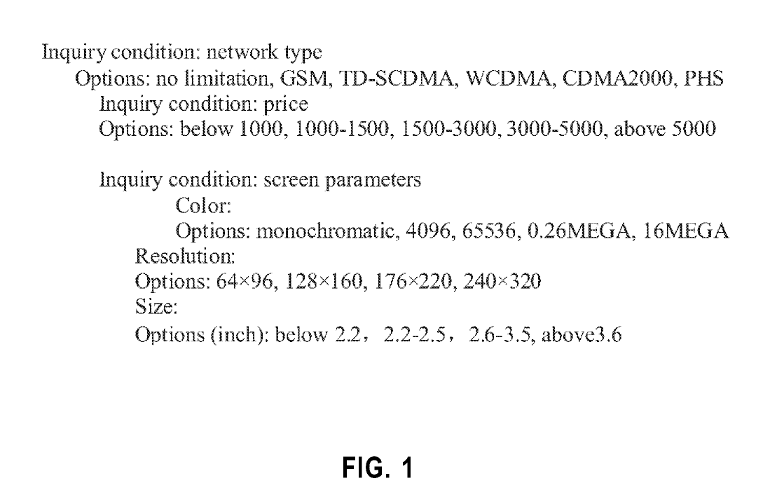

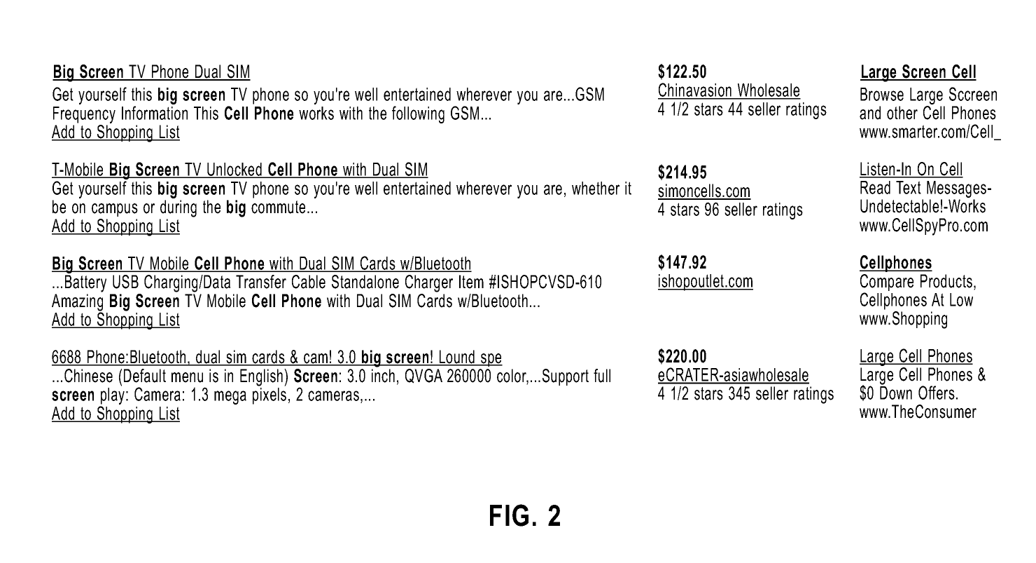

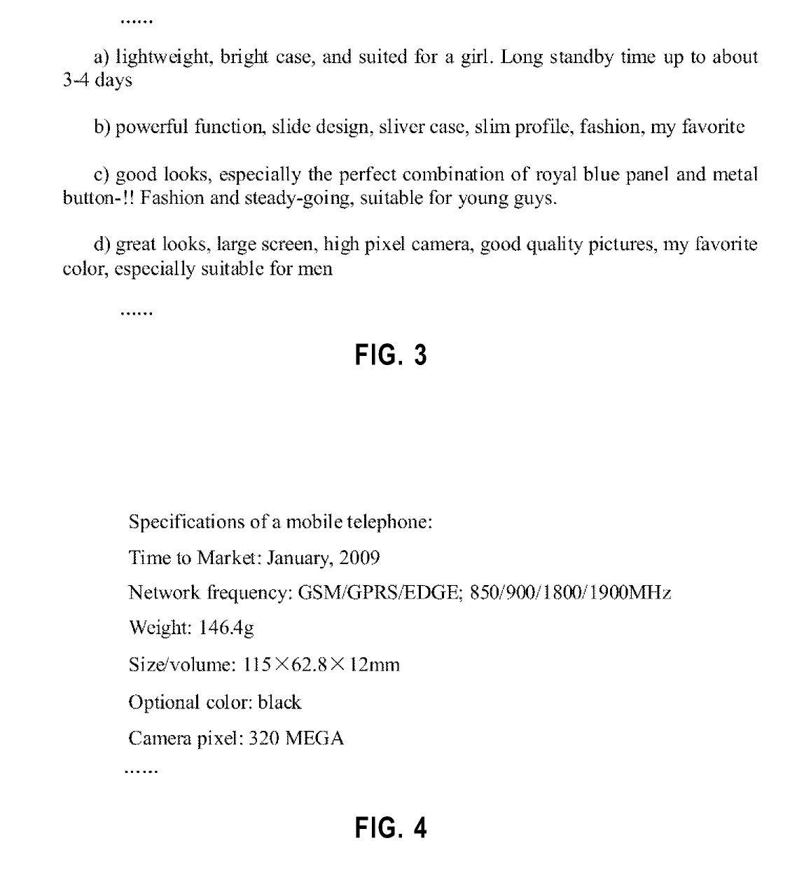

### DESCRIPTION OF PREFERRED EMBODIMENTS

Now detailed descriptions will be made of illustrative embodiments of the present invention. Examples of the embodiments are illustrated in the accompany figures, wherein same reference numbers always denote same components. It should be understood that, the present invention is not limited to the disclosed illustrative embodiments. It also should be understood that, not each feature of a method and device illustrated herein is indispensable for practicing the present invention claimed in any claim. Furthermore, in the whole disclosure, when a process or method is shown or described, steps of the method can be performed in any sequence or be executed simultaneously, unless it is clear from the context that one step depends on the proceeding execution of another step. Further, there can be significant time interval between steps.

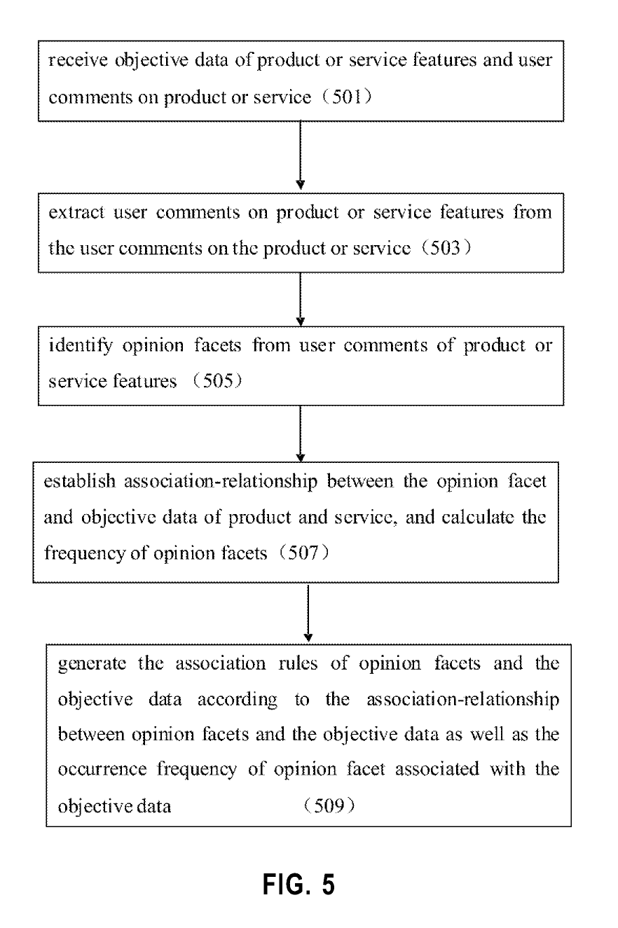

An embodiment of the present invention is described in detail by referring to FIG. 5. In step 501, objective data of a feature of a product or service and user comments on the product or service are received. Generally, each manufactured product is provided with a product design description and user manual containing detailed specifications, physical arguments and use guidance, such as physical arguments, specifications, model, cost and the like of electronic products such as mobile telephone and digital camera. A software product also will be provided with corresponding descriptions or user manual and the like. For service industry such as electronic trade, entertainment, travel, catering, hotel reservation, plane ticket reservation, etc., there are also corresponding objective descriptive indices, such as, star level of a hotel, price, supporting facilities, traffic, location etc. All these real objective data can serve as origin of the above mentioned objective data of features of products or services. And user comments can come from comments on related products or service in the internet, or can come from market survey by journals, even by manufactures or service providers, or come from comments of specialists, etc. The present invention is not limited to a specific source of user comments. Further, the products or services can be products of the same type but of different models or services of the same type but of different levels from the same manufacture or service provider, or can be products or services of the same type from different manufactures or service providers. Further, various products or services correspond to various objective data. Of course process can be performed only on objective data and user comments of the same product or service.

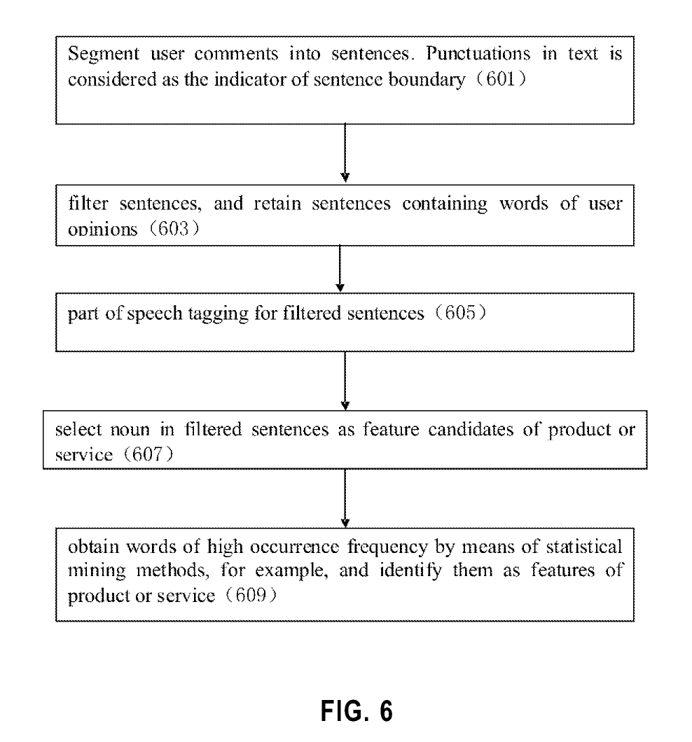

Proceeding to step 503, user comments associated with the feature of the product or service are extracted from the user comments on the product or service. To do this, any existing methods for identifying a feature of a product or service can be adopted. With the feature identified, user comments associated with the feature can be determined naturally. FIG. 6 shows a preferred method for identifying user comments on a feature of a product or service according to an embodiment of the present invention, which are described in detail below.

In step 505, an opinion facet in the user comments associated with the feature of the product or service is identified, and to facilitate the understanding of a product feature and an opinion facet, examples are given as follows:

### Example 1

Product feature: weight

Opinion facet: a very light equipment; easy for carrying with; small model, fit the female; thin shape.

### Example 2

Product feature: screen

Opinion facet; clear color; big size; a large number of pixels

A plurality of learning models can be used to analyze, extract and identify the opinion facet in user comments associated with features of a product or service, such as K-means cluster model, Bayesian classifying model. As a preference, Topic models can be used to analyze the user comments associated with features of a product or service, to identify the opinion facet of the product of service.

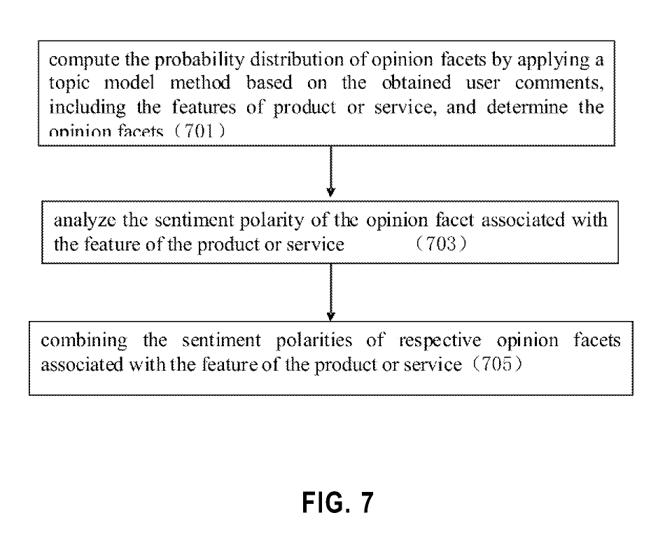

FIG. 7 illustrates detailed how to identify an opinion facet with a topic model algorithm. In step 505, two-item tuple, formed as <feature of product/service; opinion facet> can be selectively generated after identifying the opinion facet, such as <weight; a very light equipment>, <weight; easy for carrying with>, <weight; fit the female>; <weight; thin shape>. Of course any other proper data structure can be used to describe product feature and corresponding opinion facet. Further, it should be considered to attach an identity of a particular product or service to the two-item tuple to designate the corresponding particular product or service to which the two-item tuple pertain.

As a preference, a polarity judge can be made on related comments of a feature. This can be done with any existing polarity judging method, for example, polarity judging based on an opinion dictionary, polarity judging based on supervised learning, etc. And accordingly triples, such as <feature of a product, opinion facet, polarity>, can be formed. Reliability or confidence degree processing on comments can be made according to a percentage distribution of polarities of comments on a feature in a particular product or service.

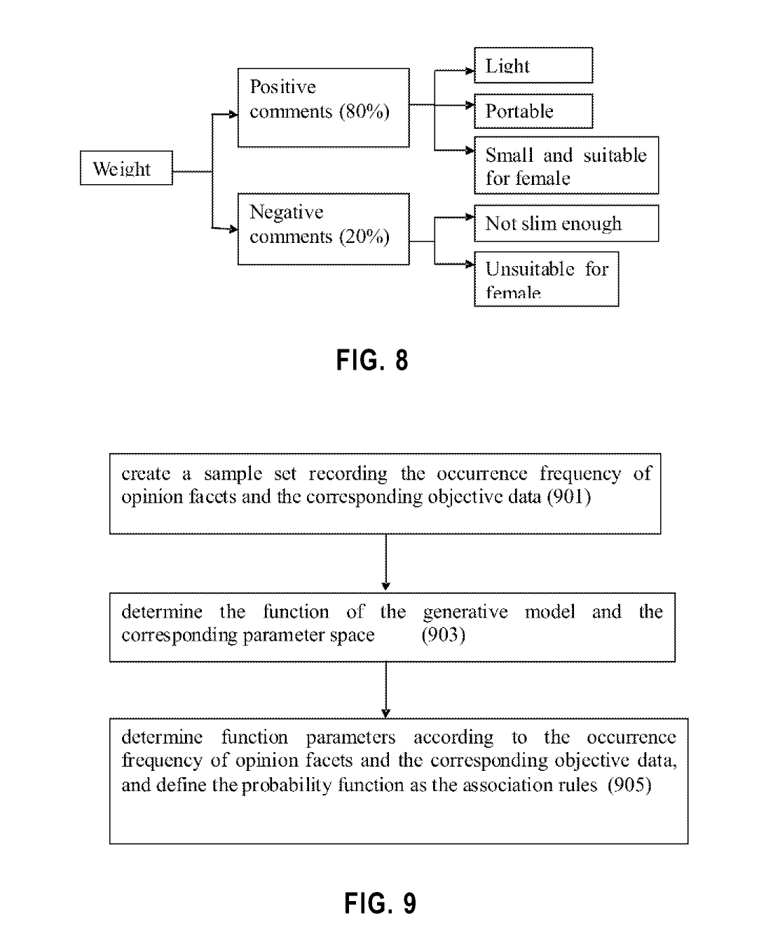

Users hold different opinions on a particular product or services, and comments are different accordingly. Generally, consistency of most opinions will be instructive for other users. Through analysis, we can know the distribution of user opinions with respect to a characteristic of a product or service. This is exemplified with FIG. 8, in which, for the weight of a particular product, 80 percent of users hold positive comments, and only 20 percent of users hold negative comments.

Accordingly, positive comments are of most significant characteristic of “weight”, and are of high reliability, while negative comments are of relatively low reliability. Therefore, we can recognize the reliability of opinion comments from the opinion analyzing result. As a preference, it might be considered to present the opinion distribution to users. Further, opinion comments for a characteristic of a particular product or service with low distribution percentage can be eliminated, for example, negative opinion comments with low appearance probability are eliminated, and only opinion comments with high distribution are selected for the succeeding steps.

For example, an opinion facet with probability lower than 20 percent can be eliminated. The probability threshold can be adjusted according to the experience of a user. Thus, the opinion facet of a normal person for a related feature of the product or service is reflected properly. Considering the polarity of opinions, in case there are plurality of products or service to be processed, it is preferable to, respectively for each specific product or service, process comments of the specific product or service collectively, then all the triples of <feature of a product, opinion facet, polarity> are processed synthetically in the succeeding steps.

Proceeding to step 507, association-relationship between the opinion facet and objective data of the corresponding feature of the product or service is established, and occurrence frequency of the opinion facet associated with the objective data is calculated. Information on a feature of a product or service and opinion facet is obtained in step 505. Combining corresponding objective data of a feature of each particular product or service with corresponding information on the feature of the product or service and opinion facet, a corresponding triple <feature of a product/service; objective data; opinion facet> can be obtained, any other proper data structure can be used to describe the association among feature of a product/service, objective data, opinion facet similarly.

Taking the weight of mobile phone as an example, for a particular mobile phone, the following triples can be obtained: <weight; 106.4 g; very light equipment>, <weight; 106.4 g; easy for carrying with>, <weight; 106.4 g; fit for the female>, and <weight; 106.4 g; thin shape>. All the same opinion facets for a related feature of a same type of product or service are synthesized, the same opinion facets corresponding to different objective data of the feature are accumulated, so that a total number N(v,s) of a opinion facet is obtained, where N(v, s) referring to the number of user comments with opinion facet s for particular objective data v, then a total number of user comments for products with the particular objective data v is accumulated (among these user comments, some might not be related with the targeted feature, e.g. the targeted feature is weight, then a piece of user comment for color of a product with the particular objective data v of weight is also considered for the N(v,s)), and a frequency f(s) of opinion facet s can be accumulated with the following equation:

f(s)=N(v, s)/N(v)

For example, assuming a product or service is mobile telephone, and to evaluate a feature of weight of various types of mobile telephone with the same opinion facet “light”, a statistic distribution of frequency is shown in table 1 (numeric values are just illustrative).

TABLE 1

| Physical | frequency |
|---|---|
| value(gram) | (%) |
| 80 | 30 |
| 102.4 | 27 |
| 115.2 | 20 |
| 146.4 | 10 |
| 160 | 8 |
| 180 | 2 |

As a variation for computing the frequency of an opinion facet, after N(v,s) is obtained, the N(v,s) can be divided by the total number of user comments only for the feature of the product having the particular objective data v, by the total number of user comments related with all features of the product, or even by the number of all user comments. In a word, there exist many methods for computing a frequency of an opinion facet.

Proceeding to step 509, an association rule of the opinion facet and the objective data according to the association-relationship between the opinion facet and the objective data as well as the occurrence frequency of the same opinion facet associated with the objective data is created. After the association-relationship between the opinion facet and the objective data, and the total number or frequency information of the same opinion facet associated with the objective data is obtained, different association rules can be formed according to the above information.

When there are a huge number of comments associated with the opinion facet, an approach of modeling a generative model can be adopted to form the association rules. Its aim is, through analysis based on a huge number of samples, to learn under what model current user comments can be obtained given the known objective parameters. An obvious advantage of doing so is, when a new product/service is known, user comments can be estimated from the generative model, thus a sentiment opinion can be obtained, and this is instructive for both a new product retrieval based on comments and a new product design based on user feedback. And, such generative model is dynamically adjustable, therefore when sample data is increased newly, new model parameter can be learned, so that the model can always reflect the up to date user comments and opinion appropriately.

Since opinion facets of users vary with time and space, of course, different generative models established specifically for data of different time or different areas and the like can best reflect a general opinion of current users. There are many choices for generative models, and many proper discrete or continuous functions, such as exponential function or Poisson distribution function, can be applied for proper samples. A general flow for generating an association rule by a generative module is as follows: create a sample set with the frequency of the opinion facet and the corresponding objective data, train a model for describing the association relationship between the frequency of the opinion facet and the objective data and compute the parameters for the model, and output the trained generative model as the association rule. In fact, many probability functions can be used as a function prototype of the generative model.

It can be assumed a parameter space of a function prototype is Θ, objective data of a feature of a product or service obtained based on for example the above table 1 is X={x₁, x₂, . . . , Xₙ}, related frequency (or total number) of a same opinion facet is Y={f₁, f₂, . . . , fₙ}, where, n is the number of different objective data of a feature of a product or service. Y substantially conforms to a probability distribution, such as the normal Gauss distribution, mixed Gauss distribution, polynomial distribution, Beta distribution, binomial distribution x². Given the formality of a probability function and samples, parameters are further estimated by use of a learning function, such as the most common EM (Expectation Maximization) algorithm, MLE (Maximum Likelihood Estimated) algorithm, or MAP (Maximum A Posteriori) algorithm.

Descriptions of generating an association rule by a method of generative model are given below by referring to FIG. 9. In step 901, a sample set is created with the occurrence frequency of the opinion facet and the corresponding objective data. Corresponding relationship ship of X-Y as shown in table 1 is formed, for example. In step 903, a probability function prototype and a parameter space of the probability function prototype is determined. Generally a probability function is estimated and selected experientially according to a curve distribution state.

With the function determined, parameters of the function are determined accordingly. It is also possible to make a trial and error by making a trial with the above common probability function as a function prototype to determine the parameter space Θ of its function, and test its correctness in the succeeding steps. In step 905, according to the occurrence frequency of the opinion facet and the corresponding objective data, the parameters of the function in the parameter space is estimated, the probability function is obtained, and used as the association rules. Therefore, based on the input X, Y, with a common MLE algorithm or MAP algorithm or any other existing algorithm, parameters θ of a probability function F are estimated in a parameter space Θ. A procedure of estimating the probability function F is briefly illustrated below by use of for example EM algorithm or MLE algorithm.

MLE (Maximum Likelihood Estimated) is a statistical method for solving parameters of related probability density function of a sample set. Parameters of the probability function F are θ, and are parameters to be estimated. Estimation of θ is to extract a sample with n values X={X₁,X₂, . . . , Xₙ}, and to estimate θ with the sampled data. Extracted frequencies Y={f₁,f₂, . . . , fₙ} of opinion facets on different values of a feature are a group of such sampled data, from which we can obtain the estimation of θ. To implement a Maximum Likelihood Estimated, a likelihood function should be defined first.

L(θ; X)=F(X₁,X₂, . . . , Xₙ|θ)

The function is maximized from among all values of all θ. Thee \hat{θ} maximizing the likelihood function is called the maximum likelihood estimate of θ. In statistical computing, the EM (Expectation-Maximization) algorithm is to find out a maximum likelihood estimate or maximum a posteriori in a probabilistic model, which has excellent convergence ability and wide application. For EM algorithm, an alternate computing is performed by alternating the following two steps, to estimate parameters of a function.

E-Step: According to the current estimate of the parameters, computing the expectation of a logarithm likelihood function Q(θ|θ^{(t)}), of which the definition is as follows:

Q(θ|θ^{(t)})=E_{X,θ}_{^{(t)}}[log L(θ; X)]

where, log is for solving natural logarithm, E is for solving expectation of a distribution function. t is number of alternations, θ^{(t)} is the estimation of parameter θ after t alternations.

M-Step: compute the estimation of parameters maximizing the logarithm expectation function

$${θ}^{( t + 1 )} = {argmax}_{θ} Q ( θ \vert {θ}^{( t )} )$$

where, θ^{(t+1)} denotes the estimation of parameters after t+1 alternations.

The parameters obtained in M-step are used for computation in another E-step, and this procedure goes on alternatively, until the estimation of parameter θ does not vary any more, thus parameters of a specific probability function in function space is determined.

After parameters of the function are determined, with an actual numeric value X as input, output of the probability function F is computed. Error between the output of the function and true Y is computed, and the obtained probability function is verified with a commonly used I-type error or other commonly used verification methods, and if a verifying criteria is satisfied, the probability function is used as the association rule between the opinion facet and the objective data, otherwise steps 903 and 905 are repeated. Herein, I-type error means a function H0 which actually holds true is rejected, and an error probability of “rejecting the true hypothesis” is generally denoted α.

It is supposed that magnitude of α can be determined as needed during verification, and it is generally specified α=0.05 or α=0.01. Preconditioned that the function H0 holds true, the probability that the actual difference is due to errors is computed according to a certain distribution rule of statistical numbers (such as, a sampled distribution of the average of samples, and sampled distribution of difference of the average of samples), the verification accepts or denies the selected probability function. If the probability of “rejecting the true hypothesis” is bigger than α, it is indicated that evidences are not enough for denying H0, then the determined function H0 should be accepted. EM algorithm, MAP algorithm and I-type error verification are all existing commonly used methods, and detailed descriptions of them are omitted herein.

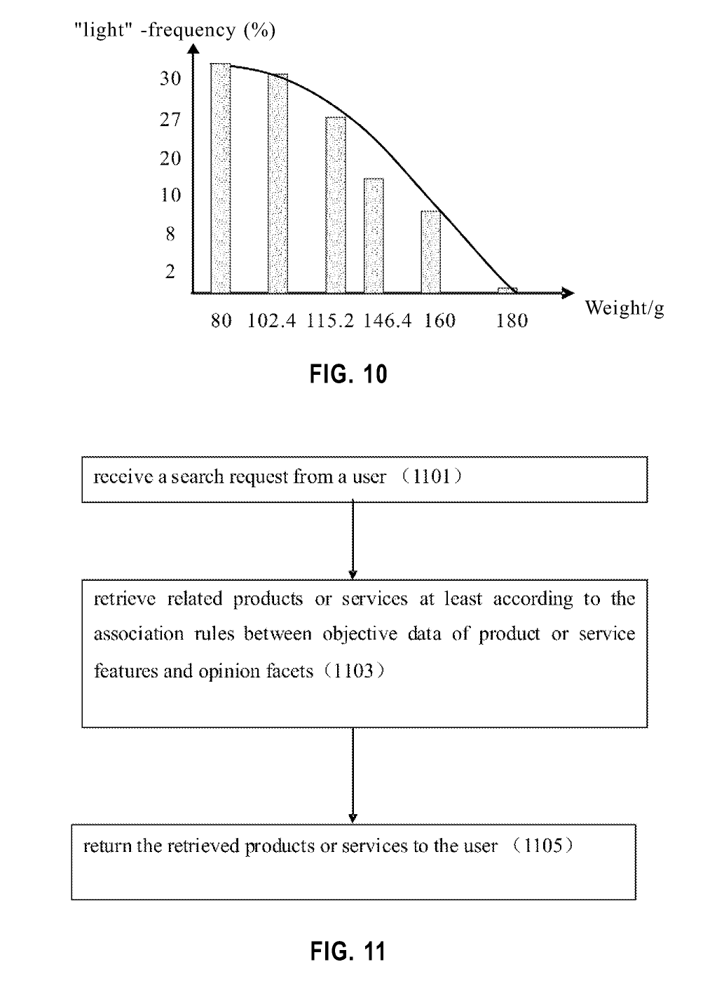

Herein, each opinion facet corresponds to a specific function as an association rule. FIG. 10 shows a probability function obtained as an association rule based on the association relationship as shown in table 1, which is a Poisson distribution

$$F ( λ , x ) = \frac{{λ}^{⌊ x / g ⌋} {e}^{- λ}}{⌊ x / g ⌋ !}$$

Taking table 1 as an example, x is an input parameter, denoting objective data such as weight; g is a basic unit, that is, the average value of objective data of samples associated with a opinion descriptive word such as “light”; λ is the probability of the opinion facet (such as “light”) in all the samples. Herein, input to the function F is actual objective data of the product or service, and output is frequency of an opinion facet, that is descriptive probability of an opinion for the actual objective data. For example, a user inquires “light mobile telephone with respect to weight”, and if a mobile telephone weights 170 g, through the above learned function, the probability the mobile telephone can be said to be light is very small, therefore such a mobile telephone does not meet requirement of the user, so it should be deleted from the retrieval result, or not be presented to the user preferentially. However, for a new product or service, even there does not exist any user comment or recommendation from a manufacture, it might be recommended to the user through the computation of the above function-association rule based on related objective data of the new product or service, and this obtains significant technical effect obviously.

As another embodiment, in case of sparse samples (for example, feature of color, or feature with only “yes/no” choice), that is, relative few opinion facets, only scattered statistic can be obtained, and thus learning of the distribution of samples do not work well, or it does not fit for the learning of samples, or only for the purpose of simple processing, at such time what is needed to do might be only to record some simple rules as shown in table 1, and to output, as the association rule, the one to one correspondence between an opinion facet and its occurrence frequency and corresponding objective data of a feature of a product or service in the description of the product or service. For example, it might be considered to output a triple rule of <objective data, opinion facet, occurrence frequency of the opinion facet>, or list of correspondence. These correspondences are checked against when a user performs retrieval, and therefore can provide a compared subject for a user and filter a good deal of inappropriate information to gain prominent technical effect.

Obtained association rules can be selectively presented to users, or be used as retrieval rules.

Now descriptions of a method for identifying a feature of a product or service are given by referring to FIG. 6. In step 601, sentence segmentation is made on user comments, with punctuations in text as a boundary decision of a sentence; in step 603, sentences are filtered, and sentences containing words of user opinions are retained; in step 605, filtered sentences are labeled with part of speech. That is, it is marked as noun or verb and the like, which can be realized by natural language processing algorithms, such as labeling of parts of speech based on hidden Markov model. In step 607, words with noun as its part of speech are selected as candidates of features of a product or service; in step 609, identification of words characterized by high occurrence frequency is performed by means of, for example, statistical mining methods, such as the existing TF-IDF algorithm or Apriori algorithm, thus words with relative high occurrence frequency are obtained, and identified as features of a product or service.

FIG. 7 illustrates in detail how to identify an opinion facet by use of existing topic model. A topic model is a probability generative model, and is used for analyzing a potential topic distribution among a set of objects. From the context of a word, a topic model can categorize all words with the same topic into a uniform topic, and distinguish words with different topics there between. Taking the generation of user comments associated with feature F of a product or service as an example, an applied topic model can treat each feature as a mixture of a plurality of different opinion facets, a generation probability of word wᵢ for feature F is described as follows:

$$P ( {w}_{i} \vert F ) = {\sum }_{j = 1}^{T} p ( {w}_{i} \vert {z}_{j} ) * p ( {z}_{j} \vert F )$$

where, p(wᵢ|zⱼ) is the generation probability of word wᵢ for opinion facet zⱼ, p(zⱼ|F) is the generation probability of zⱼ for feature F, where i is the sequential number of a word, j is the sequential number of an opinion facet, T is the total number of opinion facets.

In step 701, a probability distribution p(w|θ) of words for opinion facets is computed by applying the topic model method based on the obtained user comments including a feature of the product or service, and an opinion facet is determined, where w {w₁, w₂, . . . , wₙ}, θ {z₁,z₂, . . . , zₙ}, n is the number of words. In processing of topic model, identification of the probability distribution of opinion facets p(wᵢ|zⱼ), is often based on the above EM algorithm or current general Gibbs Sampling algorithm.

For each iteration, it is required to update values of p(zⱼ|F) and p(zⱼ|F) parameters correspondingly until convergence. With “light” as an example, based on the obtained related user comments containing feature comments “weight” (F), firstly tf*idf value of word wᵢ (for example, light) in each comments is computed (where, tf is the probability distribution p(w) of “light” in a single piece of comment, and idf is the inverse document frequency of “light” in all documents), as a computation weight in the topic model. The distribution p(zⱼ|F) of opinion facets (topic) in comments on “weight” and the distribution p(wᵢ|zⱼ) of word w in opinion facets can be computed by use of the topic model. An opinion facet to which a word belongs can be computed through:
p(zⱼ|F)

For example, comments such as “a mobile telephone is easy for carrying with”, “convenient for carrying with” can be classified to topic i by computing the maximum probability of its topic distribution, “small model, fit for the female”, “women like such compact model” and the like belong to topic j, where, i and j are the topics in the topic model respectively and comments under different topics belong to different opinion facets respectively. The topic model method belong to the prior art, so detailed description are omitted here for space saving. And optionally, determination can be made on sentiment polarity of an opinion facet.

In step 703, a sentiment polarity of an opinion facet associated with the feature of the product or service is analyzed by existing methods, such as polarity determination based on a sentiment dictionary and polarity determination based on a supervised learning. In step 705, sentiment polarities of respective opinion facets associated with the feature of the product or service are combined, and the relationship of a feature of a product or service, polarity, and opinion facet as shown in FIG. 8 is obtained. The summary figure gives the ratio between “positive” comments and “negative” comments. The obtained sentiment polarity summary can then be selectively presented to a user, or be used as a reference in the succeeding steps.

Further, an information retrieval method is described in detail by referring to FIG. 11. In step 1101, a search request from a user is received. The search request from a user includes some sentiment descriptive keywords, for example, the search request of “light in weight fit for the female mobile telephone”; in step 1103, information on related product or service is retrieved at least according to an association rule formed by the above described embodiments in conjunction with the search request from the user. The association rule can be stored in a memory in advance, and the association rule stored in advance is accessed and used during retrieval.

Of course, retrieval can be made based on a newly generated association rule. For example, with the above probability function as an association rule, for opinion facets “light” and “fit for the female”, respective probability functions are formed as association rules. And for simplicity, only weight of a mobile telephone is discussed herein. Corresponding distribution probabilities of respective various weights are calculated by the probability function for the opinion facets of “light” and “fit for the female”, such as, various weights with high distribution probability for the opinion facets of “light” and “fit for the female” are selected, and the intersection of various weights with high distribution probability for the opinion facets of “light” and “fit for the female” are identified.

For example, “light” corresponds to a weight range of [80 g 140 g], “fit for the female” corresponds to a weight range of [90 g 160 g], and the intersection of the synthesized range of weight is [90 g 140 g]. Therefore, based on the physical arguments of product provided by a mobile telephone manufacture, search can be made for mobile weight within the range of [90 g 140 g]. This function can support the retrieval of a new mobile telephone without any manufacture or user comments, thus achieves prominent technical effect.

In step 1105, the retrieved information on the product or service is sent to the user. As an alternative way, products or services obtained according to rules other than the above association rules can also be included in the retrieval results. In such case, the products or services retrieved according to the above association rule are presented to the user with priority. Another embodiment mode is such: a secondary retrieval can be made on the first round result, and the result by the secondary retrieval is presented to a user with priority.

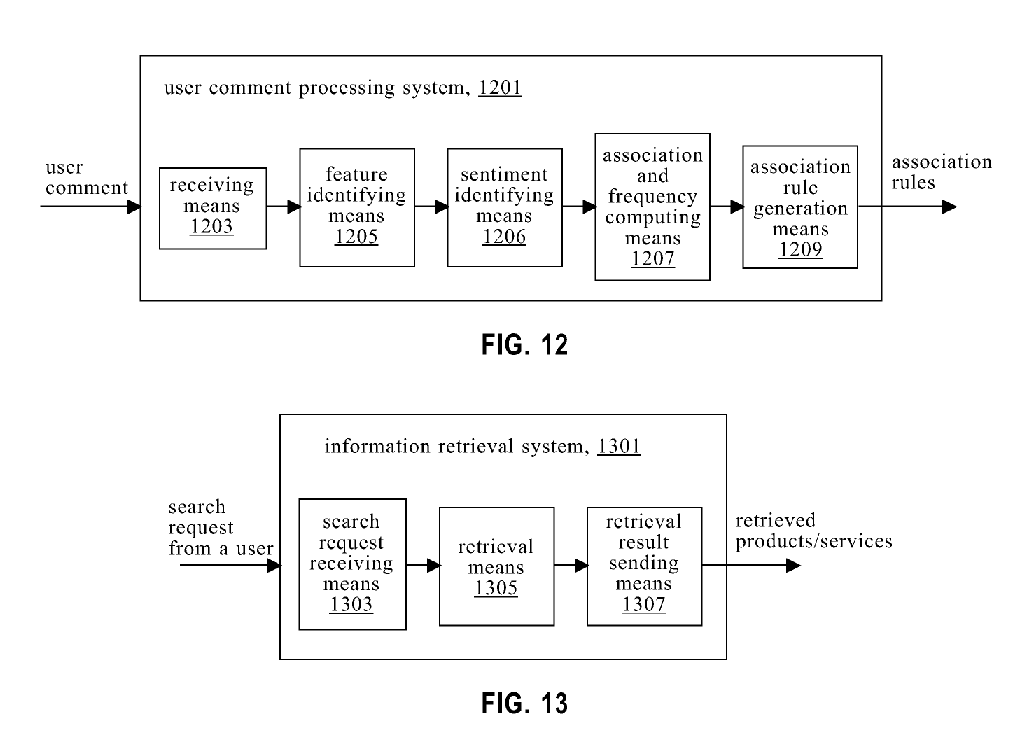

As another embodiment, FIG. 12 gives the detailed illustration of user comment processing system 1201. The system includes a receiving means 1203, a feature identifying means 1205, a sentiment identifying means 1206, an association and frequency computing means 1207, and an association rule generation means 1209. The receiving means 1203 is for receiving objective data of a feature of a product or service and user comments on the product or service. The feature identifying means 1205 is for identifying user comments associated with the feature of the product or service from the user comments on the product or service. The feeling identifying means 1206 is for identifying opinion facets in the user comments associated with the feature of the product or service. The association and frequency computing means 1207 is for associating the opinion facets with the objective data of the corresponding feature of the product or service, and calculating the occurrence frequency of the opinion facet associated with the objective data. The association rule generation means 1209 is for creating an association rule of the opinion facets and the objective data according to the association-relationship between the opinion facets and the objective data as well as the occurrence frequency of the opinion facet associated with the objective data.

Further, the association rule generation means 1209 may include means for using the one to one corresponding relationship among the objective data, the opinion facet and the occurrence frequency of the opinion facet as the association rule of the opinion facet and the objective data. The user comment processing system 1201 may further include: means for acquiring objective data of a feature of a new product or new service, wherein there do not exist related user comments for the new product or new service; and means for determining the opinion facets of the new product or new service and the occurrence frequency of the opinion facet according to the association rule.

The sentiment identifying means 1206 may include means for computing, based on the obtained user comments on the feature of the product or service, the opinion facet associated with the feature of the product or service by applying a topic model method. The user comments processing system 1201 may further include: means for analyzing a sentiment polarity of an opinion facet associated with the feature of the product or service; means for combining sentiment polarities of all opinion facets associated with the feature of the product or service, and computing the sentiment percent ratio; and eliminating the unreliable opinion facet with low sentiment percent ratio.

The association and frequency computing means 1207 may include: means for computing the total number of user comments of the opinion facet corresponding to the objective data, computing a total number of comments on the product or service with said objective data, and dividing the total number of user comments of the opinion facet corresponding to the objective data by the total number of comments on the product or service with said objective data to obtain the occurrence frequency of the opinion facet associated with the objective data

According to another aspect, the present invention provides an information retrieval system 1301 as shown in FIG. 13. The information retrieval system 1301 includes search request receiving means 1303, retrieval means 1305, and retrieval result sending means 1307. The search request receiving means 1303 is for receiving a search request from a user. The retrieval means 1305 is for retrieving information on related products or services at least according to an association rule formed by above embodiments in conjunction with the search request from the user. The retrieval result sending means is for sending the retrieved information on the products or services to the user.

Further, the user comment processing method and information retrieval method of the present invention also can be implemented with a computer program product. The computer program product includes a software code section which is executed, when the computer program product is run on a computer, to implement the emulation method of the present invention.

The present invention can also be implemented by recording a computer program into a computer readable recording medium. The computer program includes a software code section which is executed, when the computer program product is run on a computer, to implement the emulation method of the present invention. That is, the procedure of the emulation method of the present invention can be distributed in the form of instructions in a computer readable medium or other various forms, regardless of what specific types of the signal carrying medium for implementing the distribution actually are. Examples of a computer readable medium includes mediums such as EPROM, ROM, tape, floppy disk, hard drive, RAM and CD-ROM, and medium of transmission type such as digital or analog communication link.

Although the present invention has been shown and described with reference to the preferred embodiments thereof, those skilled in the art will understand that various changes and modifications in forms and details can be made to the embodiments without departing the principles and spirits of the present invention and they still fall into the scope of claims and the equivalent thereof.

What is claimed is:

1. A computer-implemented method for processing user comments, comprising the steps of:
receiving objective data of a feature of a product or service and user comments on the product or service, said user comments including comments associated with said feature;
identifying user comments associated with the feature of the product or service from the other user comments on the product or service;
identifying an opinion facet in the user comments associated with the feature of the product or service;
establishing association-relationship between the opinion facet and the objective data of the corresponding feature of the product or service, and calculating an occurrence frequency of the opinion facet associated with the objective data; and
creating an association rule between the opinion facet and the objective data according to said association-relationship and said occurrence frequency of the opinion facet associated with the objective data;
wherein each of the steps is performed by a data processing machine.

2. The method of claim 1 wherein, the step of creating includes:
creating a sample set with the occurrence frequency of the opinion facet and the corresponding objective data;
determining a probability function prototype and a parameter space of the probability function prototype; and
estimating, according to the occurrence frequency of the opinion facet and the corresponding objective data in the sample set, the parameters of the function prototype in the parameter space so as to obtain the probability function, and using the probability function as the association rules of the opinion facet and the objective data.

3. The method of claim 2 wherein, the step of estimating further includes:
determining the validating of the obtained probability function with an occurrence frequency of the opinion facet and a corresponding objective data; and
when the result is not valid, (i) repeating the step of determining a probability function prototype and a parameter space of the probability function prototype; (ii) repeating the step of estimating, according to the occurrence frequency of the opinion facet and the corresponding objective data in the sample set, the parameters of the function prototype in the parameter space so as to obtain the probability function; and (iii) using the probability function as the association rules of the opinion facet and the objective data.

4. The method of claim 1 wherein, the step of creating an association rule includes:
using the one to one corresponding relationship among the objective data, the opinion facet and the occurrence frequency of the opinion facet as the association rule of the opinion facet and the objective data.

5. The method of claim 1, further comprising:
acquiring objective data of a feature of a new product or new service for which there do not exist related user comments; and
determining an opinion facet and a occurrence frequency of the opinion facet according to the association rule.

6. The method of claim 1, wherein, the step of identifying an opinion facet includes:
computing the opinion facet associated with the feature of the product or service by applying a topic model method, based on obtained user comments including a feature of the product or service.

7. The method of claim 6, further comprising:
analyzing a sentiment polarity of an opinion facet associated with a feature of the product or service;
combining sentiment polarities of respective opinion facets associated with the feature of the product or service, and computing a percent ratio of sentiment polarity; and
eliminating an opinion facet with low percent ratio of sentiment polarity.

8. The method of claim 1 wherein, the step of calculating the occurrence frequency of the opinion facet associated with the objective data includes:
computing a total number of user comments including the opinion facet corresponding to the objective data;
computing a total number of comments on the product or service with said objective data; and
dividing the total number of user comments including the opinion facet corresponding to the objective data, by the total number of comments on the product or service with said objective data to obtain the occurrence frequency of the opinion facet associated with the objective data.

9. The method of claim 1, further comprising:
receiving a search request from a user;
retrieving information on related products or services according to the association rule; and
sending the retrieved information on the product or service to the user.

10. The method of claim 9, further including:
presenting said retrieved information to the user with priority over other information sent to the user.

11. A system for processing user comments, comprising:
receiving means for receiving objective data of a feature of a product or service and user comments on the product or service;
feature identifying means, for identifying user comments associated with the feature of the product or service from the user comments on the product or service;
sentiment identifying means for identifying an opinion facet in the user comments associated with the feature of the product or service;
association and frequency computing means for establishing association-relationship between the opinion facet and the objective data of the corresponding feature of the product or service, and calculating an occurrence frequency of the opinion facet associated with the objective data; and
association rule generation means for creating an association rule of the opinion facet and the objective data according to said association-relationship and said occurrence frequency of the opinion facet associated with the objective data.

12. The system of claim 11, wherein the association rule generation means comprises:
means for creating a sample set with the occurrence frequency of the opinion facet and the corresponding objective data;
means for determining a probability function prototype and a parameter space of the probability function prototype; and
means for estimating, according to the occurrence frequency of the opinion facet and the corresponding objective data in the sample set, the parameters of the function prototype in the parameter space so as to obtain the probability function, and using the probability function as the association rules of the opinion facet and the objective data.

13. The system of claim 11, wherein the association rule generation means comprises:
means for using the one to one corresponding relationship among the objective data, the opinion facet and the occurrence frequency of the opinion facet as the association rule of the opinion facet and the objective data.

14. The system of claim 11, further comprising:
means for acquiring objective data of a feature of a new product or new service, wherein there are no related user comments for the new product or new service; and
means for determining the opinion facet of the new product or new service and the occurrence frequency of the opinion facet according to the association rule.

15. The system of claim 11, wherein, the sentiment identifying means comprises:
means for computing, based on the obtained user comments on the feature of the product or service, the opinion facet associated with the feature of the product or service by applying a topic model method.

16. The system of claim 15, further comprising:
means for analyzing a sentiment polarity of an opinion facet associated with the feature of the product or service;
means for combining sentiment polarities of respective opinion facets associated with the feature of the product or service, and computing a percent ratio corresponding to a sentiment polarity; and
means for eliminating an opinion facet with a low percent ratio of sentiment polarity.

17. The system of claim 11 wherein, the association and frequency computing means comprises:
means for (i) computing a total number of user comments including the opinion facet corresponding to the objective data, (ii) computing a total number of comments on the product or service with said objective data (iii) and dividing the total number of user comments including the opinion facet corresponding to the objective data by the total number of comments on the product or service with said objective data to obtain the occurrence frequency of the opinion facet associated with the objective data.

18. A computer-readable storage medium tangibly embodying computer executable program instructions which, when executed, cause a computer to perform the method of claim 1.
